(19) United States
(12) Patent Application Publication
(10) Pub. No.: US 2019/0387862 A1
(43) Pub. Date: Dec. 26, 2019

(54) EPILATION DEVICE WITH INTERCHANGEABLE HEAD TO SUPPLY WAX AND HAIR REMOVAL PAPER

(71) Applicant: Universidad Americana, Asuncion (PY)

(72) Inventors: Blanca DUARTE DE BAEZ, Asuncion (PY); Esteban Ortellado, Asuncion (PY); Sara Nendoza Testi, Asuncion (PY); Aldo Amarilla, Limpio (PY)

(21) Appl. No.: 16/032,470

(22) Filed: Jul. 11, 2018

(30) Foreign Application Priority Data
Jun. 22, 2018 (PY) P 1848910

(51) Int. Cl. A45D 26/00; A45D 40/26; B05C 17/025; B65H 75/22; A47K 10/38

(52) U.S. Cl. CPC A45D 26/0014; A45D 40/261; A45D 2200/155; B65H 75/22; A47K 10/38; B05C 17/025

(57) ABSTRACT

The present invention relates to a device for epilation, based on the concept of an element with an interchangeable head, which, in a first case, allows the installation of a head that dispenses wax for epilation, while in a second case, it allows the installation of a head that dispenses paper for hair removal, in other words, when the device is in use, it allows the user to dispense wax on the area from which hair is to be removed, and then simply switch the head to supply the paper and thus remove the hair easily, quickly, and adequately, without requiring multiple devices. The wax dispenser head is therefore equipped inside with a mechanism that allows the wax to be heated while at the same time it is pushed outwards to be supplied to the user simply and adequately, while the paper dispenser head allows the paper to be delivered by means of the same rotating movement, all controlled from a main control module that corresponds essentially to an activation/deactivation mechanism for the entire system, and also includes a safety element that allows the functioning of the device to be blocked or locked in the case of problems due to the temperatures that are used.

### CROSS REFERENCE TO RELATED APPLICATION

This application claims priority of Paraguay Application No. P 1848910 PY filed Jun. 22, 2018, application which is incorporated herein by reference.

### FIELD OF THE INVENTION

The present invention may be included in the field of household appliances, specifically, but not limited solely to the area of women's beauty and care. More specifically, the object of the invention relates to a device that helps with epilation in three simple processes, wherein said device is based on the concept of an element with an interchangeable head, which, in a first case, allows the installation of a head that dispenses wax for epilation, while in a second case, it allows the installation of a head that dispenses paper for removal of hair, in other words, when the device is in use, it allows the user to dispense wax on the area from which hair is to be removed, and then simply switch the head to supply the paper and thus remove the hair easily, quickly, and adequately, without requiring multiple devices.

With that in mind, the wax dispenser head is equipped inside with a mechanism that allows the wax to be heated while at the same time it is pushed outwards to be supplied to the user simply and adequately, while the paper dispenser head allows the paper to be delivered by means of the same rotating movement, all controlled from a main control module that corresponds essentially to an activation/deactivation mechanism for the entire system, and also includes a safety element that allows the functioning of the device to be blocked or locked in the case of problems due to the temperatures that are used.

### BACKGROUND OF THE INVENTION

Currently, it is well known that the process of epilation is an activity that is carried out periodically, and undoubtedly, one of the most widely-used methods of epilation, not because it is the best but rather because it corresponds to the most traditional form of carrying out the process and which give practically perfect results, is normally done in a beauty center by applying and removing wax, which allows the hair to be removed to adhere to the wax and be pulled out successfully. Similar epilation devices exist in the state of the art, but they have a series of drawbacks, as will be defined later in this disclosure.

The existing solutions in state of the art correspond mainly to warm wax devices that can be used easily at home, in other words, they do not require qualified personnel to carry out the epilation process, but rather the user can perform the process personally, and make use of the aforementioned wax, which adheres to the hair. Hot wax is a molten resin that grips the hair, whether short, fine, long, or abundant, and pulls it out by the root. Thus the hot wax is presented in small resin balls that must be melted at a certain temperature in order to become a solution or fluid that can be spread over the area from which the hair is to be removed. This fluid is applied to the skin with the help of a spatula made of any material, preferably wood, or with a roll-on that pours a dose of wax. Once dry, the wax adheres to the hair without releasing it and it is then pulled off with a strong jerk using a paper or external element that also adheres to the wax and allows the user to pull it to remove said wax.

With that in mind, hot wax is the most effective epilation technique that currently exists on the market, due to the fact that the heat of the wax opens the pores of the skin and the hair comes out more easily. Despite the fact that since the appearance of laser epilation, wax no longer enjoys the same popularity, wax epilation continues to be an option that in high demand by people who cannot expose their skin to lasers, such as men and women with tattoos on their legs and thighs.

Some of the similar solutions found in the state of the art include patent No. U.S. Pat. No. 8,882,382 B2 titled “Device for applying epilation wax with precision”, {00041378 } which discloses a device used to apply epilation wax, which allows precise application in terms of thickness, but which has a presentation in the form of a knob and that must be discarded after each use; in other words, it is not reusable, which increases production and manufacturing costs, and that at the same time represents an environmental problem due to the waste that is generated, because every time the product is loaded, a new one must be purchased.

Likewise, the disclosures of the state of the art include application WO 2012082579, which discloses a device for the application of epilation wax with precision, which comprises a body that contains a wax for epilation, a head that comprises an open housing equipped with longitudinal and transversal side walls, wherein the housing receives a movable applicator mounted in rotation in the housing. The device defined in this document has a mobile applicator that is a wheel or roller whose side walls are dome shaped, in order to permit adequate application of the wax on the skin of the user.

In addition, the document U.S. Pat. No. 5,219,237 discloses a device for epilation that uses liquid wax applied on the skin, wherein the device has a heating element positioned at one end of the wax reservoir and a wax applicator distributor roller, wherein said was applicator roller rotates. The device comprises a housing with a reservoir to maintain a block of wax. Said reservoir is connected to an outlet opening in one wall of the housing, and wherein the rotating distributor roller is positioned near the outlet opening to apply the liquid wax directly on the skin.

Likewise, document FR 2659204 mentions a wax applicator to remove hair, wherein said applicator is constructed based on a cover that houses a sleeve, with resistance elements applied to the lateral and external surfaces, a head that holds an applicator roller that forms a body in a single piece with the corresponding storage containing the wax. Said storage has a configuration with a shape that is complemented by the shape of the sleeve, in order to fit there, and to obtain heating of the wax contained in said storage by means of the resistance elements.

The state of the art also includes the document CN 205125389, which is related to roller-type wax applicator device, ideal for epilation in users, wherein said device comprises a housing, a cavity defined within the housing, a deflector installed in the cavity which separates it for the heating of a reservoir for the wax. The device also includes a brush and a roller for the application of the wax, as well as an internal wire for heating the wax to allow it to be applied on the skin of the user.

Lastly, the document ES 2024226 shows a unit for the application of wax during epilation, which has an interchangeable head, wherein the device consists of an assembly made up of a movable wax application device that has a mechanism for the interchanging of the applicator heads, and a wax heating melter, and which maintains the temperature until the wax is applied on the skin from which the hair is to be removed.

According to the information provided above, and which is disclosed in the state of the art, it is clear that there is a need to design and implement an epilation wax applicator device, which makes it possible to perform two epilation tasks with a single device, in other words, without requiring additional elements to apply the wax on the skin of the user and that can then supply or dispense the paper or fabric that is used to remove the hair, which is as similar as possible to what is done in specialized beauty salons, but allowing users to carry out the process easily and conveniently at home. Likewise, the device must also be reusable and not require the purchase of additional accessories or a new device every time that the epilation process needs to be carried out.

### SUMMARY OF THE INVENTION

The present invention relates to a removable epilation device with three pieces intended to be attached and removed to and from the top part of the handle, wherein the pieces are mounted on the corresponding shaft, wherein the device of the present invention allows the entire epilation process to be carried out easily, quickly, and adequately, because it allows the wax to be heated inside the device, dispensed to apply it to the skin, and by simply changing the heat at the top part, the paper or suitable element can be supplied to remove the solidified wax along with the hairs.

Likewise, the epilation device of the invention comprises a handle with a central shaft designed to be secured on one of the heads, wherein the handle contains a central rotating shaft, which, when the device is assembled, turns the heads, and which is equipped with a metal element that corresponds to a resistive element that is heated and thus makes it possible to melt the wax that is located inside the first head or the head the corresponds to the dispensing of wax in liquid form.

In this sense, the main objective of the present invention is to facilitate epilation from the skin to avoid frequent hair removal, wherein it is a device with a configuration that allows the pieces to be easily assembled and disassembled, without requiring specialized external tools or complex assembly/disassembly procedures.

Another objective of the present invention is to facilitate epilation without the need to go to a beauty center, allowing users to carry out the epilation directly in their homes, without requiring additional elements or highly qualified personnel, thus reducing the cost associated with these beauty procedures that must be carried out constantly and frequently.

### BRIEF DESCRIPTION OF THE FIGURES

The present invention is understood more clearly based on the following figures, which show the different components, parts, or steps associated with the present device, system, or method, as well as the novel elements with respect to the state of the art, wherein the figures are not intended to limit the scope of the invention, which is determined solely by the attached claims, wherein:

FIG. 1 shows the device of the present invention without including any type of head on its top part, illustrating the internal rotating shaft and the device that anchors the shaft to the handle.

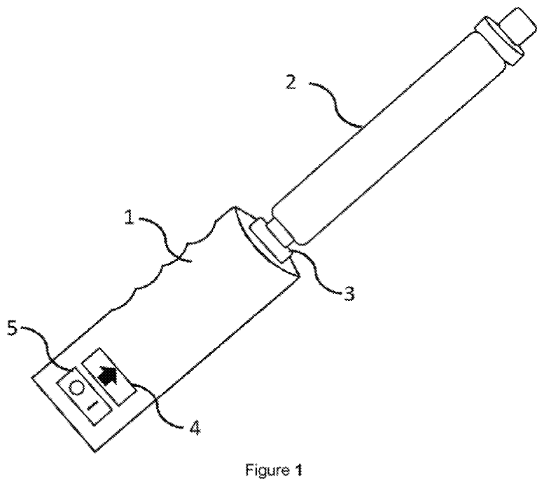

FIG. 2 shows a front elevation view of the epilation device with a non-slip handle and with is equipped with a wax dispenser head, which, by means of an opening in the dispenser itself, hot wax is discharged, pushed by the spring and the thrust ring. This figure also shows the button for the activation and deactivation of the device, as well as the unlocking of the rotating shaft to change it.

FIG. 3 shows an interior view of the epilation device, illustrating the spring that is used to push the wax, and it also shows the metal heater that is located on the rotating shaft.

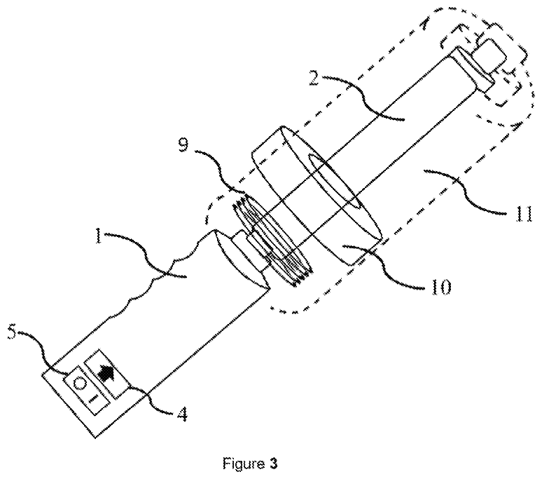

FIG. 4 shows a general view of a head for dispensing special paper for removing wax.

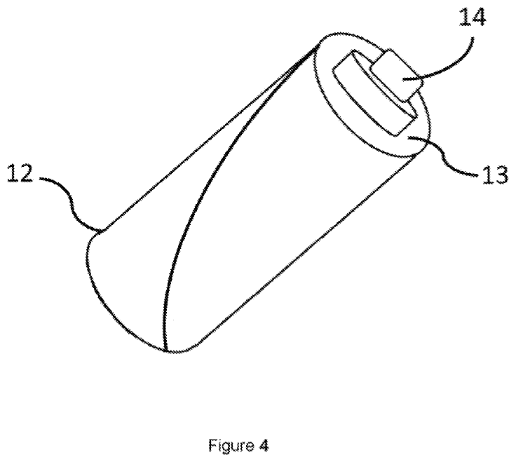

### DETAILED DESCRIPTION OF THE INVENTION

The figures described above are not to scale. The current dimensions of each one of the components may vary depending on the needs of the user. The most significant details of the device of the invention are highlighted so that a person who does not have experience in the area can clearly understand the concept.

The present invention is intended to be a epilation device with interchangeable head for the supply of wax and hair removal paper, which makes it possible to easily, quickly, and adequately carry out a epilation process similar to the service provided in a specialized beauty salon, but with the advantage that it can be carried out directly by the user at home, without the need for complex elements or additional accessories that increase the cost of the operation and that must be assumed by said user.

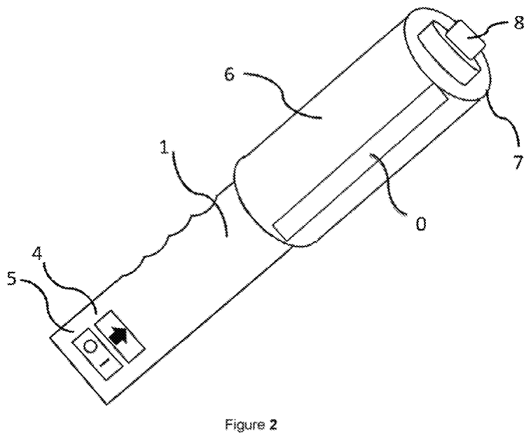

With that in mind, the device of the present invention comprises the following components and/or parts, wherein the function and interaction of each one of these will be defined later:
A main body made up of a non-slip handle 1 located at the bottom of the device and that allows the user to grip it, connected at the top to a rotating shaft 2 by means of a handle anchor 3 wherein said rotating shaft 2 is located at the top of the device and is that will allow the wax or hair removal paper to be dispensed and heated, depending on which head is installed on the non-slip handle 1;
A control and locking module preferably made up of an activation and/or deactivation interface or button 5 that allows the operation of the device to begin, or to turn off the device, and a locking/unlocking element 4 that allows the functioning of the device to be locked and thus leave the activation and/or deactivation interface or button 5 inoperative, wherein said locking is done by any known mechanical means that blocks the operation of said interface or button 5;
A first wax dispenser head 6 that is located at the top of the non-slip handle 1, wherein said first head 6 is interchangeable and removable, which corresponds to a cylindrical body inside which the wax to be dispensed to the user is housed. Said first head 6 is in turn made up of
   A cylindrical body, as described above, that corresponds to the external structure in relation to the user;
   A cover 7 located at the distal end or tip of the head, away from the non-slip handle 1, and that allows the interior of the cylindrical body to be sealed, wherein preferably, said cover 7 is removable to provide access to the interior of the cylindrical body;
   A shaft support 8 that corresponds to a protrusion above the cover 7 that makes it possible to support the rotating shaft 2 that is located inside the cylindrical body when the first head 6 is installed in its position on the handle 1;
   A spring 9 located at the bottom of the cylindrical body and closer to the handle anchor 3, wherein, when the first head 6 is installed, said spring 9 is wrapped or rolled around the rotating shaft 2, but without making contact with it, and allows the generation of a thrust that will help dispense the wax when it is hot and transforms from a solid to a liquid;
   A thrust element 10 located above the spring 9, and which, as its name indicates, allows the wax to be pushed thanks to the force applied by the spring 9 to be able to dispense it to the user when the control mechanism of the epilation device is activated; and
   A wax reservoir 11 that occupies a large part of the interior of the cylindrical body of the wax dispenser head 6, wherein said reservoir stores the wax in solid state, to heat it and then dispense it in liquid state to the user;
   An opening 0 arranged vertically, which is shown more clearly in FIG. 2, through which opening 0 the wax, which, when heated, changes from its solid state to a liquid state, is discharged, pushed by the spring 9 and the thrust element or ring 10.
A second hair removal paper dispenser head 12 which is interchangeable and is located in the same position as the first head 6, in other words, where first head 6 for dispensing the wax, or the second head 12 for dispensing the material with which the wax is removed along with the hair, in other words, after the wax has been applied, can be installed on the non-slip handle 1, wherein said second head 12 is made up of:
   A cylindrical body that corresponds to the external structure of the second head 12, similar to the one defined in the first head 6;
   A cover 13 located at the distal end or tip of the head 12, away from the non-slip handle 1; and that makes it possible to seal the interior of the cylindrical body;
   A shaft support 14 that corresponds to a protrusion above the cover 13 that makes it possible to support the rotating shaft 2 that is located inside the cylindrical body when the second head 12 is installed in its position on the handle 1; and
A motor (not shown) and a resistive element (not shown) located inside the non-slip handle 1, wherein said motor and the resistive element are connected directly to the rotating shaft 2 and to the activation and/or deactivation interface or button 5, wherein the movement of the motor is rotational and allows the rotation of the rotating shaft 2, and the resistive element heats the external surface of said rotating shaft 2 in order to obtain a heating element located inside the head (preferably, the wax dispenser head 6), in order to heat the wax and transform it from a solid to a liquid and to be able to dispense it or supply it to the end user.

With that in mind, preferably, the main body, at the bottom, specifically that part that corresponds to the non-slip handle 1, is equipped with a series of slits that allow the user to have a better grip on the device when using it in the epilation process. Although the figures illustrate a non-slip handle 1 with carved areas or rounded slits that would correspond to the shape of the fingers of the user when the device is held by said handle 1, the present invention is not limited solely to this shape, which is preferred, but rather on the contrary, the non-slip handle may contain any type of pattern or element that allows a better grip, such as several protrusions above the surface, irregular and different slits, and similar forms, wherein the objective of said element is solely to improve the grip on the device by the user.

In an alternative arrangement, the control and locking module may correspond to a panel that allows the adjustment of the temperature of the heating element inside the device, for example, the rotating shaft 2, as well as the speed of rotation of the rotating shaft 2. Preferably, said module corresponds to display interface with the user, in which the user can program the aforementioned parameters, and it may include a button or element for locking/unlocking the device, in other words, a function that allows the operation of the device to be blocked in order to change the head, corresponding to a safety device for the user.

In a preferred embodiment, the thrust element 10 corresponds to a ring that is positioned around the rotating shaft 2 and is a solid element that withstands the thrust applied by the spring 9, without deforming or being damaged, thus guaranteeing the adequate supply of the heated wax, in other words, in liquid state, to be able to be applied on the skin of the user, wherein said thrust element 10 may also be a conductor of heat and is heated thanks to its contact with the rotating shaft 2, which allows the wax inside the reservoir 11 to melt more easily and be applied in liquid form in an easier and more suitable manner for the user.

During operation, said thrust element 10 that is in shape of a ring is used to push the wax that is located in its top part, in other words, inside the wax reservoir 11, where due to the pressure exerted by the spring 9, said thrust element 10 moves up inside the reservoir 11 until it reaches the top of the cylindrical body and thus, the wax inside is used completely, thus indicating the end stop or run.

In addition, the motor is located in the internal part of the non-slip handle 1, as indicated previously, wherein preferably said motor is an AC (alternating current) motor and is responsible for moving the rotating shaft 2 and heating it to melt the wax. During operation, the activation button 5 allows the rotating shaft 2 to begin to turn and applies heat to it, so that the wax can melt and it is possible to carry out the epilation procedure.

By means of the device of the present invention, the wax can be distributed on the surface from which hair is to be removed using the wax dispenser head 6 installed directly on the non-slip handle 1, as indicated previously, then changing the wax dispenser head 6 for another roller that corresponds to the paper head 12 that has the paper to remove the wax, wherein this procedure makes it possible to remove the hair.

1. An epilation device with interchangeable head to supply wax and hair removal paper, comprising:
a main body made up of a non-slip handle located at the bottom of the device, connected at the top to a rotating shaft by means of a handle anchor wherein said rotating shaft is located at the top of the device;
a control and locking module that controls the operation of the device and its components, and its activation and/or deactivation;
a first wax dispenser head located at the top of the non-slip handle, and wherein said first head is interchangeable and removable and is made up of:
an external structure or housing;
a cover located at the distal end of the head, away from the non-slip handle, wherein said cover is removable;
a shaft support that corresponds to a protrusion above the cover;
a spring located at the bottom of the structure, closer to the handle anchor;
a thrust element located above the spring; and
a wax reservoir that occupies a large amount of the interior of the first head;
a wax dispensing opening arranged vertically.
a second head for dispensing hair removal paper which is interchangeable and located in the same position and location as the first head, with said second head consisting of:
an external structure;
a cover located at the distal end of the head, away from the non-slip handle; and
a shaft support that corresponds to a protrusion above the cover.

2. The epilation device according to claim 1, further comprising a motor and a resistive element, located inside the non-slip handle, and connected to the rotating shaft and the control and locking module.

3. The epilation device according to claim 1, wherein the non-slip handle has slits or a grip pattern to increase the grip on the device by the user.

4. The epilation device according to claim 1, wherein the control and locking module is made up of an activation and/or deactivation interface or button, and an element to lock/unlock the device.

5. The epilation device according to claim 1, wherein the control and locking module corresponds to a panel to adjust the temperature of the heating element inside the device, and the speed of rotation.

6. The epilation device according to claim 1, wherein the external structure of the first head and/or the external structure of the second head corresponds to a cylindrical body.

7. The epilation device according to claim 1, wherein the thrust element corresponds to a ring that is positioned around the rotating shaft and is a solid element.

8. The epilation device according to claim 7, wherein the thrust element is a conductor of heat and comes into direct contact with the rotating shaft.

9. The epilation device according to claim 2, wherein the motor is an AC (alternating current) motor and moves and heats the rotating shaft.
